(19) United States
(12) Patent Application Publication
(10) Pub. No.: US 2003/0154830 A1
(43) Pub. Date: Aug. 21, 2003

(54) Reversible adjustable wrench

(76) Inventor: Arthur Wu, Taichung Hsien (TW)

Correspondence Address: BROWDY AND NEIMARK, P.L.L.C., 624 NINTH STREET, NW, SUITE 300, WASHINGTON, DC, 20001-5303, US

(21) Appl. No.: 10/078,453

(22) Filed: Feb. 21, 2002

(51) Int. Cl. B25B 13/00

(52) U.S. Cl. 81/186

(57) ABSTRACT

A reversible adjustable wrench comprises a handle having a fixed jaw and a guiding slot at an end of the handle. The fixed jaw has two slots at lateral sides thereof, each of which defines two stopping potion at lateral sidewalls thereof. A movable jaw has an end thereof slidable received in the guiding slot of the handle. An adjusting worm is to drive the movable jaw moving toward and away from the fixed jaw. A rotatable device has two body potions received in the slots. A pin passes through the body potions and the fixed jaw for pivoting the rotatable device at the fixed jaw. The rotatable device has a holding potion, which connects to ends of the body potions, facing the movable jaw, and an elastic member has an end being against the fixed jaw and the other end being against the rotatable device to drive the holding potion of the rotatable device turning to the tip end of the fixed jaw for the rotatable being against the topping potion of the fixed jaw, such that the holding potion of the rotatable device can be turned to the proximal end of the fixed jaw.

### FIELD OF THE INVENTION

The present invention related to a wrench, and more particularly to a reversible adjustable wrench.

### BACKGROUND OF THE INVENTION

In prior art, when use an adjustable wrench to turn a nut (or a bolt), it has to disengage the nut after turning an angle. And then, turns the adjustable wrench returning to the initial angle and reengages the adjustable wrench to the nut again for driving the nut to turn. User has to repeat the procedures described above to turn tight or to turn loose the nut.

FIG. 1 shows a conventional reversible adjustable wrench 90, which is capable of turning a nut without having to disengage and reengage the nut. The adjustable wrench 90 disposes two round channels 911 and 921 at the fixed jaw 91 and the movable jaw 92 respectively. Two racket rods 93 and 94, which have teeth faces 931 and 941 on outer ends thereof, are slidable received in the round channels 911 and 921 respectively. Two elastic members 95 and 96 are disposed at the fixed jaw 91 and the movable jaw 92 respectively for pushing the racket rods 93 and 94 respectively.

In use, user drives the movable jaw 92 moving toward the fixed jaw 91 to make the teeth faces 931 and 941 of the fixed jaw 91 and the movable jaw 92 holding a nut N. After that, user can turn the adjustable wrench 90 clockwise to drive the nut N to turn. On the contrary, when user turns the adjustable wrench 90 counterclockwise, the nut N will drive the racket rods 93 and 94 sliding into the round channels 911 and 921, such that the adjustable wrench 90 can turn backward but without driving the nut N to turn. Thus, the adjustable wrench 90 can turn a nut or a bolt without having to disengage and reengage the nut or the bolt repeatedly.

Hereunder are the disadvantages of the conventional reversible adjustable wrench 90 as described above:

1. The adjustable wrench 90 defines the teeth faces 931 and 941 of the racket rods 93 and 94 to hold the edges of the nut N. It will easy to damage the nut N when turning.

2. The adjustable wrench 90 is to turn the nuts in a range of different dimensions. It will have nuts of specific dimensions, which cannot be held by the teeth faces 931 and 941 stably.

3. If user drives the movable jaw 92 too close to the fixed jaw 91, the racket rods 93 and 94 will be pushed into the round channels 911 and 921 and the fixed jaw 91 and the movable jaw 92 will be against the nut N directly. Thus, the adjustable wrench 90 will loose the capability of reversible turning the nut.

### SUMMARY OF THE INVENTION

The primary object of the present invention is to provide a reversible adjustable wrench, which has the capability of reversible turning a nut or a bolt but without the drawbacks as described above.

According to the objective of the present invention, an adjustable wrench comprises a handle having a fixed jaw and a guiding slot at an end of the handle. The fixed jaw has at least one stopping potion thereon. A movable jaw has an end thereof slidable received in the guiding slot of the handle. An adjusting worm is to drive the movable jaw moving toward and away from the fixed jaw. A rotatable device is pivoted at the fixed jaw to be turned relative to the fixed jaw. The rotatable device has a holding potion facing the movable jaw, and an elastic member is disposed between the fixed jaw and the rotatable device to drive the holding potion of the rotatable device turning to the tip end of the fixed jaw for the rotatable being against the topping potion of the fixed jaw, such that the holding potion of the rotatable device only can be turned to the proximal end of the fixed jaw.

### BRIEF DESCRIPTION OF THE DRAWINGS

FIG. 1 is a section view of a prior art;

FIG. 2 is a front view of a first prefer embodiment of the present invention;

FIG. 3 is partial perspective view of the first prefer embodiment of the present invention, showing the rotatable device mounted on the fixed jaw;

FIG. 4 is a front view of the first prefer embodiment of the present invention, showing force of the nut exerted on the rotatable device when turning the wrench forward;

FIG. 5 is a front view of the first prefer embodiment of the present invention, showing force of the nut exerted on the rotatable device when turning the wrench backward;

FIG. 6 shows the reversible adjustable wrench of the first prefer embodiment of the present invention turning reversibly, wherein FIG. 6a showing the wrench at initial position, FIG. 6b showing the wrench turning reversibly to 30 degrees and FIG. 6c showing the wrench turning reversibly to 60 degrees;

FIG. 7 is a front view of the first prefer embodiment of the present invention, showing the relative positions of a large nut and a small nut to the rotatable device;

FIG. 8 is partial perspective view of a second prefer embodiment of the present invention, showing the rotatable device mounted on the fixed jaw;

FIG. 9 is a partial front view of the second prefer embodiment of the present invention, showing the adjustable wrench turning a large nut;

FIG. 10 is a partial front view of the second prefer embodiment of the present invention, showing the adjustable wrench turning a small nut, and

FIG. 11 is a partial perspective view of a third prefer embodiment of the present invention, showing the rotatable device mounted on the fixed jaw.

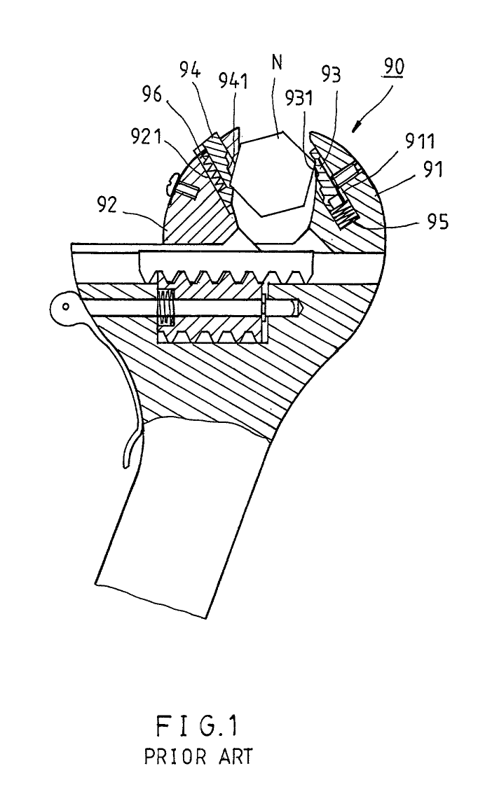

### DETAIL DESCRIPTION OF THE INVENTION

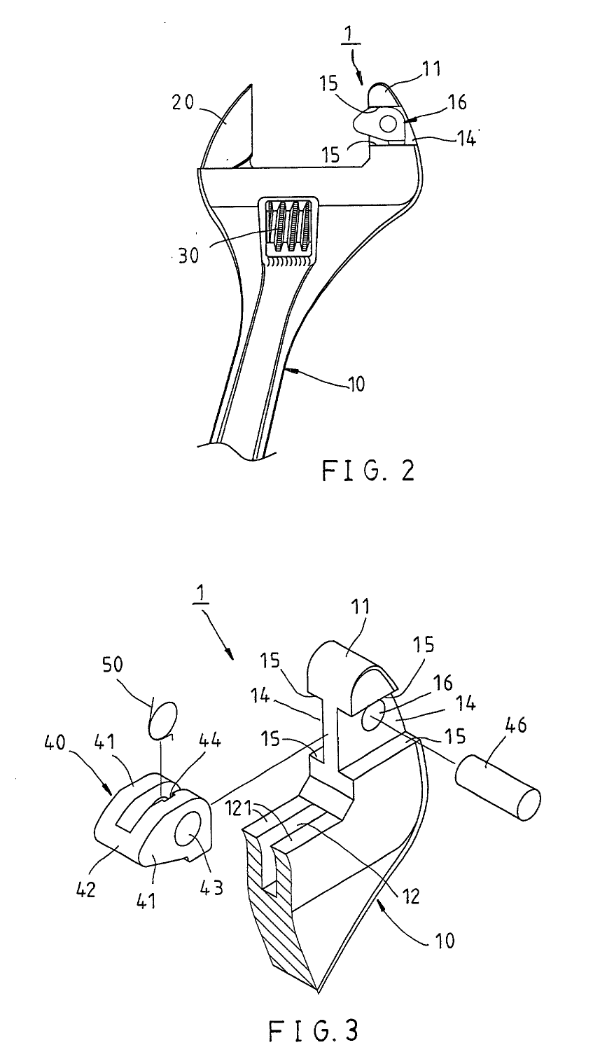

Please refer to FIG. 2 and FIG. 3, the first prefer embodiment of the present invention provides a reversible adjustable wrench 1 comprises:

A handle 10 has a fixed jaw 11 at an end thereof and a guiding slot 12 beside the fixed jaw 11. The handle 10 defines two sliding surfaces 121 at topside of the guiding slot 12.

A movable jaw 20 has an end slidable received in the guiding slot 12 of the handle 10.

An adjusting worm 30 is pivoted on the handle 10 for driving the movable jaw 20 to slide toward or away from the fixed jaw 11.

The elements as described above are as same as the conventional adjustable wrench. The main characters of the present invention will be described hereunder.

The fixed jaw 11 is disposed two slots 41 at opposite sides thereof respectively. The sidewalls of the slots 41 are defined as stopping potions 15. The fixed jaw 11 further has an axial hole 16, which has opening ends at bottom sides of the slots 41 respectively.

A rotatable device 40 has two parallel body potions 41 and a holding potion 42 connecting to ends of the body potions 41. Each body potions 41 has an opening 43. One body potion 41 disposes a hollow potion 44 at interior side thereof around the opening 43. The rotatable device 40 is disposed on the fixed jaw 11 of the handle 10 with the body potions 41 being received in the slot 14 respectively and with the holding potion 43 facing the movable jaw 20. A pin 46 inserts into the openings 43 of the body potions 41 and the axial hole 16 of the fixed jaw 11 to pivot the rotatable device 40 on the fixed jaw 11.

An elastic member 50, which is a torsional spring in the present embodiment, is disposed in the hollow potion 44 of the rotatable device 40. The elastic member 50 has an end thereof fastening to the rotatable device 40 and the other end thereof being against the stopping potion 15 of the fixed jaw 11. Thus, the initial potion of the rotatable device 40 is that the body potions 41 are against the stopping potions 15 of the fixed jaw 11, in which the rotatable device 40 is locating at the dead point of the holding potion 42 turning to the tip end of the fixed jaw 11. The rotatable device 40 can be turned to the proximal end of the fixed jaw. When the external force is gone, the elastic member 50 will drive the rotatable device 40 returning to the initial position.

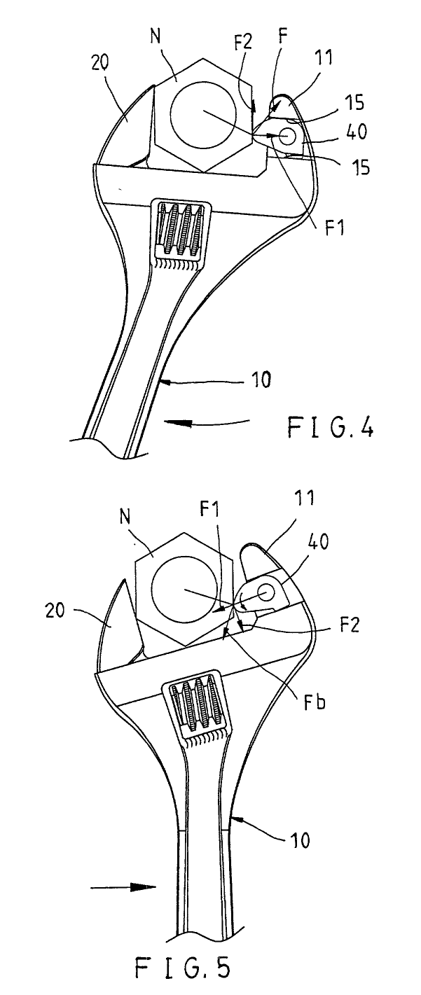

In use, please refer to FIG. 4, user turns the adjusting worm 30 to drive the movable jaw 20 and the holding potion 42 of the rotatable device 40 being against the opposite sides of a nut N (or a bolt). User only needs to turn the adjusting worm 30 till he/she cannot turn it anymore, the adjustable wrench 1 of the present invention will hold the nut N fixedly. It has same operating as the conventional adjustable wrench.

Now user can turn the adjustable wrench 1 of the present invention clockwise to drive the nut N to turn. FIG. 4 shows the nut N exerting a force F on the rotatable device 40 when turning clockwise. In analyzing the force F, it can be resolved into a horizontal component F₁ and a vertical component F₂. The pin 46 will oppose F₁. F₂ provides the rotatable device 40 a clockwise moment, which is opposed by the stopping potions 15 being against the rotatable device 40. Thus, the rotatable device 40 is fixed in turning to drive the nut N to turn.

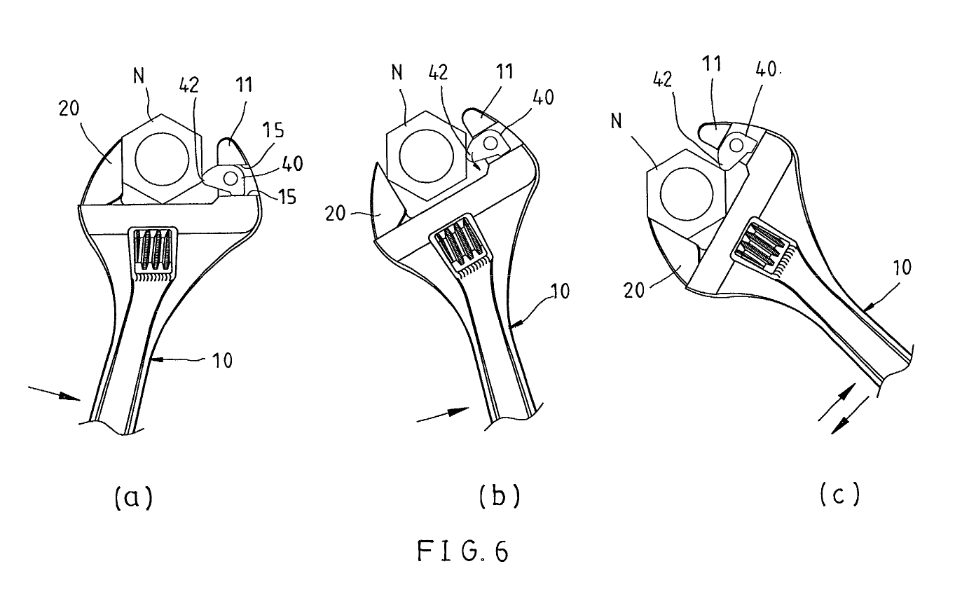

If user turns the adjustable wrench 1 reversibly, please refer to FIG. 5, the nut N will exert a force F_{b} on the rotatable device 40. F_{b} is resolved into a horizontal component F₁, and a vertical component F₂ too. The pin 46 will oppose F₁ and F₂ will provide the rotatable device 40 a counterclockwise moment to make the holding potion 42 turning to the proximal end of the fixed jaw 11. Thus, please refer to FIG. 6a to FIG. 6c, the adjustable wrench 1 of the present invention can be turned reversibly under the circumstance of not driving the nut N to turn. While the adjustable wrench 1 turns reversibly 60 degrees as shown in FIG. 6c, user can turn it clockwise again to drive the nut N to turn. Whereby, the adjustable wrench 1 of the present invention can drive a nut (or a bolt) to turn repeatedly without having to disengage and reengage the nut.

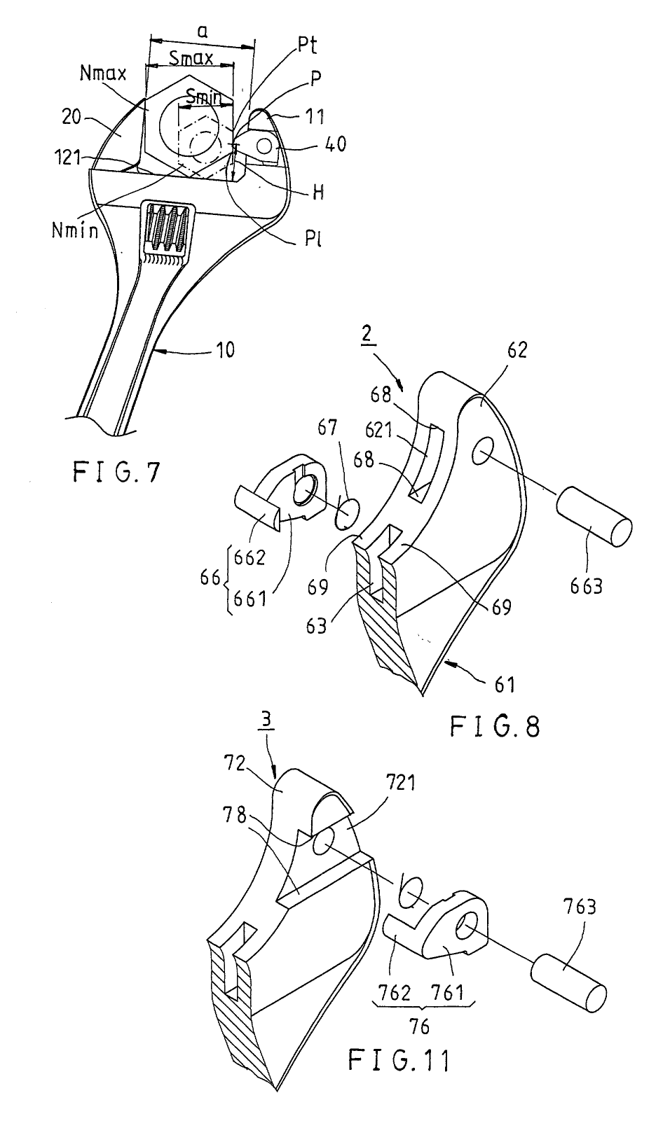

I have to mention here, the adjustable wrench 1 of the present invention provides the rotatable device 40 to be against the lateral side of the nut. But the adjustable wrench is to drive nuts or bolts of different dimensions. So, the position of the rotatable device 40 is limited in a predetermined range. Please refer to FIG. 7, the holding potion 42 of the rotatable device 40 must locate between the top edge Pₜ of the minimum nut Nₘᵢₙ, which is the smallest nut to be turned, and the lower edge P₁ of the maximum nut Nₘₐₓ, which is the largest nut to be turned. So the height H rotatable device 40 between the sliding surface 121 and the point holding potion 42 touching the nut N is limited under the formula hereunder:

$$\frac{{S}_{max}}{2} \times tan {30}^{∘} < H < \frac{{S}_{min}}{2} \times tan {60}^{∘}$$

Wherein: Sₘᵢₙ is the dimension of the minimum nut to be turned Sₘₐₓ is the dimension of the maximum nut to be turned

According to my experience of manufacturing adjustable wrenches, I recommend the position of the rotatable device 40 should be under the range defined in the table under:

| Size of | | | Height of the | maximum distance of | |
|---|---|---|---|---|---|
| adjustable | Minimum nut | Maximum nut | rotatable device | the fixed jaw and the | |
| wrench | (Smin) | (Smax) | (H) | movable jaw (A) | H/A |
| 100 | 6.2 | 12.4 | 3.6˜5.4 | 13 | 0.28˜0.41 |
| 150 | 9.3 | 18.7 | 5.4˜8.1 | 19 | 0.28˜0.42 |
| 200 | 9.3 | 23.7 | 6.9˜8.1 | 24 | 0.29˜0.34 |
| 250 | 12.3 | 28.0 | 8.1˜10.7 | 28 | 0.29˜0.38 |
| 300 | 12.7 | 33.0 | 9.5˜11.0 | 34 | 0.28˜0.32 |
| 375 | 15.3 | 41.5 | 12.0˜13.3 | 43 | 0.28˜0.31 |
| 450 | 17.7 | 50.7 | 14.6˜15.3 | 52 | 0.28˜0.29 |
| 600 | 23.0 | 58.8 | 17.0˜19.9 | 62 | 0.27˜0.32 |

The fifth column shows the minimum values of the maximum distances between the fixed jaw 11 and the movable jaw 20 of different size adjustable wrenches defined in ISO. The last column of the above table shows the ratio of the height of the rotatable device and the maximum distance of the fixed jaw 11 and the movable jaw 20 in adjustable wrenches of different sizes. Manufacturers can make the adjustable wrenches 1 disclosed in the present invention according to the table.

Please refer to FIGS. from FIG. 8 to FIG. 10, the second prefer embodiment of the present invention provides an adjustable wrench 2, which comprises a handle 61 having a fixed jaw 62 and a guiding slot 63 at an end thereof, a movable jaw 64, an adjusting worm 65, a rotatable device 66 and an elastic member 67. The adjustable wrench 2 of the second prefer embodiment is similar to the adjustable wrench 1 of the first prefer embodiment, except that the rotatable device 66 of the second prefer embodiment is a T-shaped element, which has a body potion 661 and a holding potion 662 at an end of the body potion 661. The fixed jaw 62 has a through hole 621 for receiving the body potion 661 of the rotatable device 66 therein. A pin is inserted into the fixed jaw 62 and the body potion 661 for pivoting the rotatable device 66 on the fixed jaw 62. The opposite sidewalls of the through hole 621 define two stopping potions 68, which has the same functions as corresponding elements of the first prefer embodiment.

The second character of the adjustable wrench 2 of the second prefer embodiment is that I provide two curved guiding tracks 69 extending from sliding surfaces 631 of the guiding slot 63 of the handle 61 to the fixed jaw 62. The movable jaw 64 has two gaps 641 corresponding to the guiding tracks 69 for the movable jaw 64 can slide closing to the fixed jaw 62 without being interference with the guiding tracks 69.

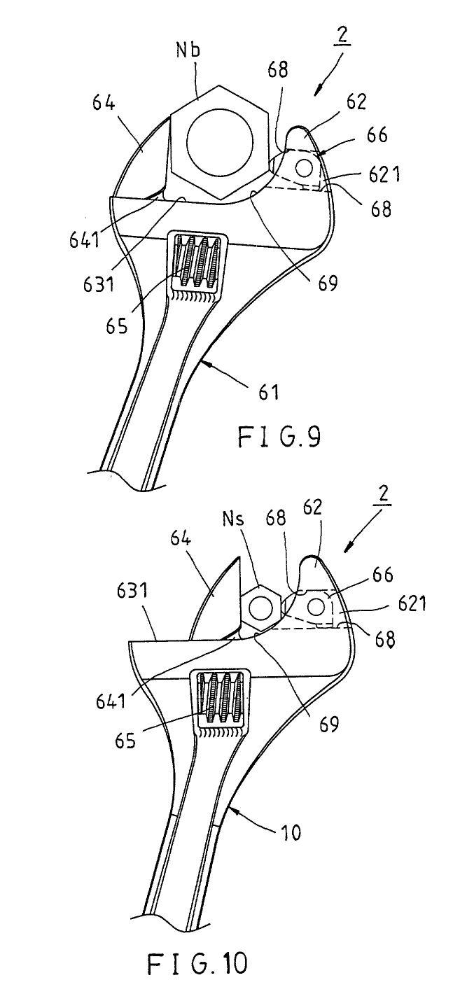

Please refer to FIG. 9, which shows the adjustable wrench 2 of the second prefer embodiment engaging to a large nut N_{b}. The bottom edge of the nut N_{b} is against the sliding surfaces 631, the movable jaw 64 and the holding potion 662 of the rotatable device 66 are against the lateral sides of the nut N_{b} respectively. This is as same as the first prefer embodiment has done.

FIG. 10 shows the adjustable wrench 2 of the second prefer embodiment engaging to a small nut Nₛ. The nut is elevated by the guiding tracks 69, such that the holding potion 662 of the rotatable device 66 will be against the lateral side of the nut. This will make the adjustable wrench 2 of the second prefer embodiment of the present invention can turn nuts or bolts of different dimensions without having to limit the precise position of the rotatable device 66.

FIG. 11 shows an adjustable wrench 3 of the third prefer embodiment of the present invention, which is similar to the embodiments of disclosed above, having a L-shaped rotatable device 76. The rotatable device 76 a body potion 761 received in a slot 761 and a holding potion 762 at an end of the body potion 761. A slot 721 is disposed at a side of the fixed jaw 72, which defines the lateral sidewalls as stopping potions 78. The body potion 761 is received in the slot 721 and a pin passes through the body potion 761 and the fixed jaw 72 for pivoting the rotatable device 76 on the fixed jaw 72. The way of operating and the function of the adjustable wrench 3 of the third prefer embodiment is as same as the embodiments of disclosed above.

What is claimed is:

1. A reversible adjustable wrench, comprising:
a handle having a fixed jaw and a guiding slot at an end of said handle; two sliding surfaces defined at the end of said handle beside the opening end of said guiding slot; said fixed jaw having at least one stopping potion;
a movable jaw having an end thereof slidable received in said guiding slot of said handle;
an adjusting worm for driving said movable jaw moving toward and away from said fixed jaw;
a rotatable device pivoted at said fixed jaw to be turned relative to said fixed jaw; said rotatable device having a holding potion facing said movable jaw, and
an elastic member disposed between said fixed jaw and said rotatable device tending to drive said holding potion of said rotatable device turning to the tip end of said fixed jaw; whereby the initial position of said rotatable device being against said topping potion of said fixed jaw, such that said holding potion of said rotatable device can be turned to the proximal end of said fixed jaw.

2. The adjustable wrench as defined in claim 1, wherein said fixed jaw has two slots at lateral sides thereof respectively, each slot defines two said stopping potions at the sidewalls thereof; said rotatable device has two substantially parallel body potions and said holding potion connecting to ends of said body potions; said body potions of said rotatable device are received in said slots of said fixed jaw respectively, and a pin inserts into said body potions and said fixed jaw for pivoting said rotatable device on said fixed jaw.

3. The adjustable wrench as defined in claim 1, wherein said fixed jaw has a through hole, which defines two said stopping potions at the sidewalls thereof; said rotatable device has a body potion and said holding potion connecting to an end of said body potion; said body potion of said rotatable device is received in said through hole of said fixed jaw, and a pin inserts into said body potion and said fixed jaw for pivoting said rotatable device on said fixed jaw.

4. The adjustable wrench as defined in claim 1, wherein said fixed jaw has a slot at a side thereof, said slot defines two said stopping potions at the sidewalls thereof; said rotatable device has two substantially parallel body potions and a holding potion connecting to ends of said body potions; said body potions of said rotatable device is received in said slots of said fixed jaw respectively, and a pin inserts into said body potions and said fixed jaw for pivoting said rotatable device on said fixed jaw.

5. The adjustable wrench as defined in claim 1, wherein the ratio of the height of said sliding surface to said holding potion of said rotatable device and the maximum distance between said fixed jaw and said movable jaw of the adjustable wrench is within the range of 0.27 to 0.42.

6. The adjustable wrench as defined in claim 1, wherein said handle has a guiding track extending from said sliding surface to said fixed jaw
